(19) United States
(12) Patent Application Publication
(10) Pub. No.: US 2021/0335205 A1
(43) Pub. Date: Oct. 28, 2021

(54) DISPLAY PANEL DRIVING SYSTEM AND DISPLAY DEVICE

(71) Applicant: TCL CHINA STAR OPTOELECTRONICS TECHNOLOGY CO., LTD., Shenzhen (CN)

(72) Inventors: Wenfang LI, Shenzhen (CN); Dan CAO, Shenzhen (CN); Xianming ZHANG, Shenzhen (CN)

(73) Assignee: TCL CHINA STAR OPTOELECTRONICS TECHNOLOGY CO., LTD., Shenzhen (CN)

(21) Appl. No.: 16/627,379

(22) PCT Filed: Dec. 11, 2019
(86) PCT No.: PCT/CN2019/124511

§ 371 Date: Dec. 30, 2019

(30) Foreign Application Priority Data
Nov. 25, 2019 (CN) 201911167647.2

(51) Int. Cl. G09G 3/20

(52) U.S. Cl. CPC G09G 3/2092; G09G 2310/08; G09G 2310/0275; G09G 2320/0673; G09G 2310/0289; G09G 2300/0842

(57) ABSTRACT

The present application provides a display panel driving system and a display device. The display panel driving system includes a memory, a timing control integrated circuit (IC), and a panel driving IC. The memory is configured to store driving data. The timing control IC is configured to download the driving data from the memory during a startup phase, and send the driving data to the panel driving IC. Therefore, multiple ICs can share a single memory, which reduces costs.

### CROSS-REFERENCE TO RELATED APPLICATIONS

This application claims the priority to Chinese Patent Application No. 201911167647.2, entitled “DISPLAY PANEL DRIVING SYSTEM” and filed on Nov. 25, 2019 with the State Intellectual Property Office of the People's Republic of China, which is entirely incorporated by reference into the present application.

### FIELD OF APPLICATION

The present application is related to the field of display technology, and specifically to a display panel driving system and a display device.

### BACKGROUND OF APPLICATION

Display panel driving systems include panel driving integrated circuits (ICs), such as a programmable gamma (P-gamma) IC and a power management IC (PMIC). These ICs have internal memory to store related data. For example, a memory in the P-gamma IC stores gamma data, a memory in the power management IC stores voltage data. The ICs drive a display panel according to driving data stored internally.

Accordingly, the ICs in current display panel driving systems have a technical problem that memories need to be configured.

### SUMMARY OF APPLICATION

The present application provides a display panel driving system and a display device to solve a technical problem that memories need to be configured in the ICs in current display panel driving systems.

In order to solve the above problem, the present application provides technical solution as follows:

the present provides a display panel driving system, including:

a memory, a timing control integrated circuit (IC), and a panel driving IC;

wherein the memory is configured to store driving data;

wherein the timing control IC is electrically connected to the memory and the panel driving IC, is configured to download the driving data from the memory during a startup phase, and send the driving data to the panel driving IC; and

wherein the panel driving IC is electrically connected to a display panel and includes an IC main body and a register, and the IC main body is configured to receive the driving data from the timing control IC during the startup phase, write the driving data into the register, and drive the display panel to work according to the driving data stored in the register during a display phase.

In the display panel driving system according to an embodiment of the present, the panel driving IC includes at least one of a programmable gamma (P-gamma) IC, a power management IC, or a level shifter IC.

In the display panel driving system according to an embodiment of the present, the memory includes flash memory.

In the display panel driving system according to an embodiment of the present, the display panel driving system further includes a control board, and the memory, the timing control IC, and the panel driving IC are disposed on the control board.

In the display panel driving system according to an embodiment of the present, the display panel driving system further includes a timing control board and a source driving control board, the memory includes a first memory and a second memory, the first memory, the timing control IC, and the panel driving IC are disposed on the timing control board, and the second memory is disposed on the source driving control board.

In the display panel driving system according to an embodiment of the present, the IC main body is configured to verify whether the driving data written to the register is correct during the startup phase, and if the driving data written to the register is not correct, the driving data from the timing control IC is reacquired and written into the register.

In the display panel driving system according to an embodiment of the present, the IC main body includes:

an acquisition unit configured to receive first driving data from the timing control IC during the startup phase;

a writing unit configured to write the first driving data into the register during the startup phase;

a verifying unit configured to detect whether second driving data stored in the register is same as the first driving data during the startup phase and to determine the driving data written to the register during the startup phase is incorrect when the first driving data is different from the second driving data; and

a rewriting unit configured to reacquire the driving data from the timing control IC and write the driving data into the register when the verifying unit determines the driving data written to the register during the startup phase is incorrect.

In the display panel driving system according to an embodiment of the present, the verifying unit is further configured to acquire a first verification code corresponding to the first driving data and a second verification code corresponding to the second driving data and compare the first verification code to the second verification code, and when the first verification code is different from the second verification code, the first driving data is determined as different from the second driving data.

In the display panel driving system according to an embodiment of the present, the verifying unit is further configured to detect whether the second driving data stored in the register is same as the first driving data during the display phase, and when the first driving data is different from the second driving data, the rewriting unit is triggered to reacquire the first driving data from the timing control IC and write the first driving data into the register.

In the display panel driving system according to an embodiment of the present, the verifying unit is further configured to detect whether the second driving data stored in the register is same as the first driving data during a blank period of a display frame, when the first driving data is different from the second driving data, the rewriting unit is triggered to reacquire the first driving data from the timing control IC and write the first driving data into the register, and when the first driving data is same as the second driving data, the IC main body drives the display panel to work according to the driving data stored in the register during a display period of a next display frame.

The present application provides a display device, including:

a display panel and a display panel driving system, the display panel driving system including a memory, a timing control integrated circuit (IC), and a panel driving IC;

wherein the memory is configured to store driving data;

wherein the timing control IC is electrically connected to the memory and the panel driving IC, is configured to download the driving data from the memory during a startup phase, and send the driving data to the panel driving IC; and

wherein the panel driving IC is electrically connected to a display panel and includes an IC main body and a register, and the IC main body is configured to receive the driving data from the timing control IC during the startup phase, write the driving data into the register, and drive the display panel to work according to the driving data stored in the register during a display phase.

In the display device according to an embodiment of the present, the panel driving IC includes at least one of a programmable gamma (P-gamma) IC, a power management IC, or a level shifter IC.

In the display device according to an embodiment of the present, the memory includes flash memory.

In the display device according to an embodiment of the present, the display panel driving system further includes a control board, and the memory, the timing control IC, and the panel driving IC are disposed on the control board.

In the display device according to an embodiment of the present, the display panel driving system further includes a timing control board and a source driving control board, the memory includes a first memory and a second memory, the first memory, the timing control IC, and the panel driving IC are disposed on the timing control board, and the second memory is disposed on the source driving control board.

In the display device according to an embodiment of the present, the IC main body is configured to verify whether the driving data written to the register is correct during the startup phase, and if the driving data written to the register is not correct, the driving data from the timing control IC is reacquired and written into the register.

In the display device according to an embodiment of the present, the IC main body includes:

an acquisition unit configured to receive first driving data from the timing control IC during the startup phase;

a writing unit configured to write the first driving data into the register during the startup phase;

a verifying unit configured to detect whether second driving data stored in the register is same as the first driving data during the startup phase and to determine the driving data written to the register during the startup phase is incorrect when the first driving data is different from the second driving data; and

a rewriting unit configured to reacquire the driving data from the timing control IC and write the driving data into the register when the verifying unit determines the driving data written to the register during the startup phase is incorrect.

In the display device according to an embodiment of the present, the verifying unit is further configured to acquire a first verification code corresponding to the first driving data and a second verification code corresponding to the second driving data and compare the first verification code to the second verification code, and when the first verification code is different from the second verification code, the first driving data is determined as different from the second driving data.

In the display device according to an embodiment of the present, the verifying unit is further configured to detect whether the second driving data stored in the register is same as the first driving data during the display phase, and when the first driving data is different from the second driving data, the rewriting unit is triggered to reacquire the first driving data from the timing control IC and write the first driving data into the register.

In the display device according to an embodiment of the present, the verifying unit is further configured to detect whether the second driving data stored in the register is same as the first driving data during a blank period of a display frame, when the first driving data is different from the second driving data, the rewriting unit is triggered to reacquire the first driving data from the timing control IC and write the first driving data into the register, and when the first driving data is same as the second driving data, the IC main body drives the display panel to work according to the driving data stored in the register during a display period of a next display frame.

The present application provides the display panel driving system and the display device. The display panel driving system includes the memory, the timing control IC, and the panel driving IC. The memory is configured to store driving data. The timing control IC is electrically connected to the memory and the panel driving IC, is configured to download the driving data from the memory during the startup phase, and send the driving data to the panel driving IC. The panel driving IC is electrically connected to the display panel and includes the IC main body and the register, and the IC main body is configured to receive the driving data from the timing control IC during the startup phase, write the driving data into the register, and drive the display panel to work according to the driving data stored in the register during the display phase. Based on this system, the timing control IC downloads the driving data from the memory during the startup phase, the panel driving IC receives the driving data from the timing control IC during the startup phase, writes the driving data to the register, and drives the display panel to work according to the driving data stored in the register during the display phase. Therefore, each IC does not need to be configured with a special memory, and multiple ICs can share a single memory, which solves a technical problem that memories need to be configured in the ICs in the current display panel driving systems and reduces costs.

### DESCRIPTION OF DRAWINGS

FIG. 1 is a first structural diagram of a display panel driving system according to an embodiment of the present application.

FIG. 2 is a second structural diagram of the display panel driving system according to an embodiment of the present application.

FIG. 3 is a third structural diagram of the display panel driving system according to an embodiment of the present application.

FIG. 4 is a fourth structural diagram of the display panel driving system according to an embodiment of the present application.

FIG. 5 is a flowchart of a driving method according to an embodiment of the present application.

### DETAILED DESCRIPTION OF PREFERRED EMBODIMENTS

The present application provides a display panel driving system. In order to make purposes, technical solutions, and effects of the present application clearer and more specific, the present application is further described in detail below with reference to the accompanying drawings and examples. It should be understood that the specific embodiments described herein are only used to explain the application, and are not used to limit the present application.

Embodiments of the present application is used to solve the technical problem that memories need to be configured in the ICs in current display panel driving systems.

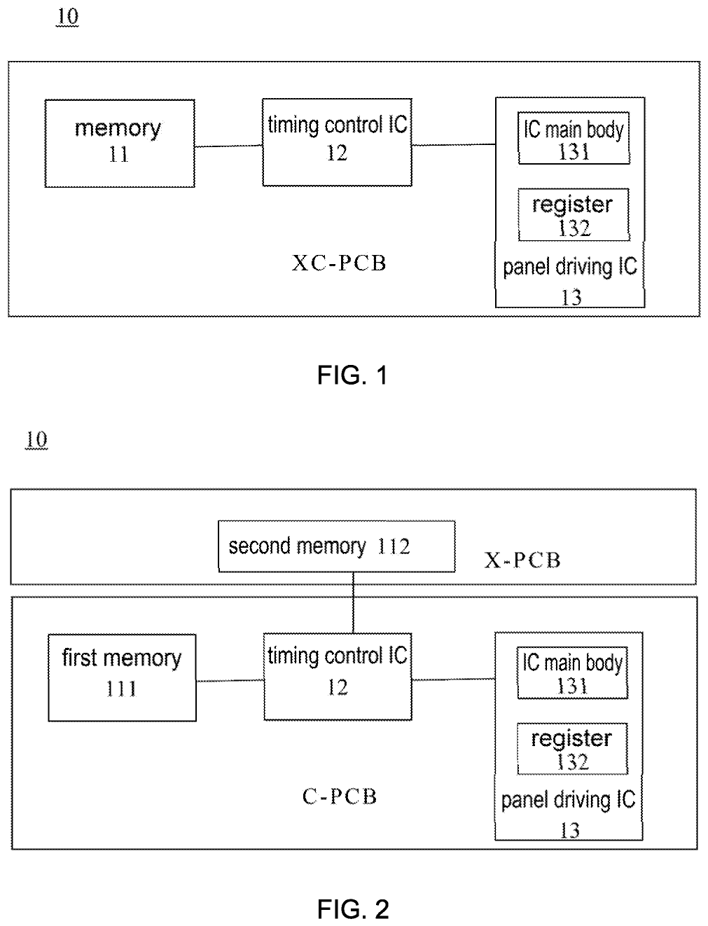

As shown in FIGS. 1 to 4, a display panel driving system 10 provided by the present application includes a memory 11, a timing control integrated circuit (IC) 12, and a panel driving IC 13.

The memory 11 is configured to store driving data.

The timing control IC 12 is electrically connected to the memory 11 and the panel driving IC 13, is configured to download the driving data from the memory 11 during a startup phase, and send the driving data to the panel driving IC 13.

The panel driving IC 13 is electrically connected to a display panel and includes an IC main body 131 and a register 132, and the IC main body 131 is configured to receive the driving data from the timing control IC 12 during the startup phase, write the driving data into the register 132, and drive the display panel to work according to the driving data stored in the register 132 during a display phase.

In the display panel driving system 10 provided by the present application, each IC does not need to be configured with a special memory, and multiple ICs can share a single memory, which solves a technical problem that memories need to be configured in the ICs in the current display panel driving systems and reduces costs.

In an embodiment of the present application, the memory includes flash memory.

In an embodiment of the present application, the panel driving IC includes at least one of a programmable gamma (P-gamma) IC, a power management IC, or a level shifter (LS) IC.

Each type of ICs needs to write different driving data. For example, the power management IC needs to write driving data such as VDD voltage and VSS voltage required by the display panel, the P-gamma IC needs to write driving data such as gamma correction corresponding to each sub-pixels of the display panel, and the LS IC needs to write driving data such as VGH voltage and VGL voltage required by the display panel.

When the driving data corresponding to at least one IC is stored in an external memory, the at least one IC does not need to be configured with a corresponding internal memory, which can reduce costs.

In an embodiment of the present application, the panel driving IC includes the programmable gamma (P-gamma) IC, the power management IC, and the LS IC.

In an embodiment of the present application, the IC main body 131 is configured to verify whether the driving data written to the register 132 is correct during the startup phase, and if the driving data written to the register 132 is not correct, the driving data from the timing control IC 12 is reacquired and written into the register 132.

In an embodiment of the present application, the IC main body 131 includes:

an acquisition unit configured to receive first driving data from the timing control IC during the startup phase;

a writing unit configured to write the first driving data into the register during the startup phase;

a verifying unit configured to detect whether second driving data stored in the register is same as the first driving data during the startup phase and to determine the driving data written to the register during the startup phase is incorrect when the first driving data is different from the second driving data; and

a rewriting unit configured to reacquire the driving data from the timing control IC and write the driving data into the register when the verifying unit determines the driving data written to the register during the startup phase is incorrect.

In an embodiment of the present application, the verifying unit is further configured to acquire a first verification code corresponding to the first driving data and a second verification code corresponding to the second driving data and compare the first verification code to the second verification code, and when the first verification code is different from the second verification code, the first driving data is determined as different from the second driving data.

In an embodiment of the present application, the verifying unit is further configured to detect whether the second driving data stored in the register is same as the first driving data during the display phase, and when the first driving data is different from the second driving data, the rewriting unit is triggered to reacquire the first driving data from the timing control IC and write the first driving data into the register.

A driving circuit of the display panel includes a gate driving IC and a source driving IC. In the present application, a printed circuit board connected to the source driving IC is referred to as a source driving control board, which is X-PCB. A printed circuit board connected to the gate driving IC is referred to as a gate driving control board, which is Y-PCB. A printed circuit board on which the timing control IC (TCON) is disposed is referred to as a timing control board, which is C-PCB.

As shown in FIG. 1, in an embodiment of the present application, the X-PCB and the C-PCB are a combined structure, which is called a control board XC-PCB. In this structure, the display panel driving system 10 includes the control board XC-PCB. The memory 11, the timing control IC 12, and the panel driving IC 13 are disposed on the control board XC-PCB.

As shown in FIG. 2, in an embodiment of the present application, the X-PCB and the C-PCB are a separated structure. In this structure, the display panel driving system 10 includes a first memory 111 and a second memory 112. The first memory 111, the timing control IC 12, and the panel driving IC 13 are disposed on the timing control board C-PCB, and the second memory 112 is disposed on the source driving control board X-PCB.

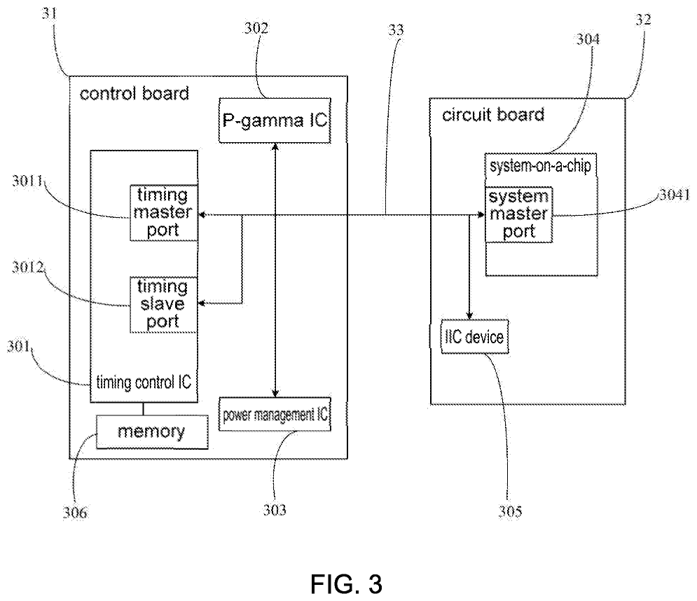

As shown in FIG. 3, in an embodiment of the present application, the X-PCB and the C-PCB are a combined structure. The display panel driving system 10 includes a control board 31 (i.e. the control board XC-PCB mentioned above), a circuit board 32, and an inter-integrated circuit (IIC) bus 32. The control board 31 includes the timing control IC (TCON) 301, the P-gamma IC 302, the power management IC (PMIC) 303, and the memory 306. The circuit board 32 includes a system-on-a-chip (SoC) 304 and an IIC device 305. The timing control IC 301 includes a timing master port 3011 for transmitting signals and a timing slave port 3012 for receiving signals. The SoC 304 includes a system master port 3041 for transmitting signals.

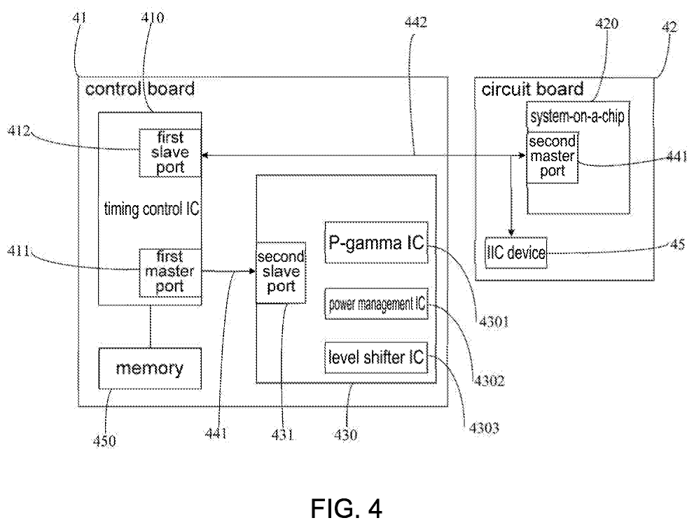

As shown in FIG. 4, in an embodiment of the present application, the X-PCB and the C-PCB are a combined structure. The display panel driving system 10 includes a first IIC bus 441, a second IIC bus 442, a control board 41, and a circuit board 42.

The control board 41 includes the timing control IC 410, the panel driving IC 430, and the memory 450. The timing driving IC 410 includes a first master port 411 and a first slave port 412. The panel driving IC 430 includes a second slave port 431. The first master port 411 is connected to the second slave port 431 through the first IIC bus 441.

The circuit board 42 includes the SoC 420. The SoC 420 includes a second master port 421. The second master port 421 is connected to the first slave port 412 through the second IIC bus 442.

The circuit board 42 is a circuit board with a SoC 420 as a core, and has various functions, such as analog signal conversing between different ports, video format decoding, video post-processing, and image on-screen display (OSD) engine. The circuit board 42 is used to send data signals, and is usually in the format of V-By-One, low voltage differential signaling (LVDS), embedded display port (EDP), and the like.

The timing control IC 410 is disposed on the control board 41. The timing control IC 410 converts data signals in the V-By-One, LVDS, and EDP formats sent from the SoC 420 in the circuit board 42 into data signals in formats of mini-LVDS, reduced swing differential signaling (RSDS), and transistor-transistor logic (TTL), which can be recognized by the display panel.

The timing control IC 410 converts the data signals, control signals, and clock signals received from the circuit board 42 into data signals, control signals, and timing signals suitable for a data driving IC and a scan driving IC, and sends them to the data driving IC and the scan driving IC. The scan driving IC provides scanning signals to scanning lines, and the data driving IC provides data signals to data lines. Therefore, image data sent from the circuit board 42 can be correctly displayed by the display panel.

The panel driving IC 430 is also disposed on the control board 41. The panel driving IC 430 includes at least one of the P-gamma IC 4301, the power management IC 4302, or the LS IC 4303.

The P-gamma IC 4301 is used to generate a gamma reference voltage.

The power management IC 4302 is mainly used to generate various voltages required for an operation of the display panel, such as digital operating voltage (DVDD) provided to each IC, analog voltage (AVDD) provided to the gamma IC4301 and a VCOM circuit, and gate-on voltage (Vgh or Von) and gate-off voltage (Vgl or Voff) provided to the scan driving IC.

The LS IC 4303 is used to level shift signals.

The IIC bus has the advantages of few signal lines, a small size, etc., and is widely used in the display panel driving systems. The IIC bus is a type of synchronous communication used to connect microcontrollers and their peripheral devices.

In this embodiment, the first IIC bus 441 is used to connect the timing control IC 410 and the panel driving IC 430, and the second IIC bus 442 is used to connect the timing control IC 410 and the SoC 420.

The timing driving IC 410 includes the first master port 411 and the first slave port 412. The SoC 420 includes the second master port 421. The panel driving IC 430 includes the second slave port 431. Data can be exchanged between master ports and slave ports through a communication.

When the timing control IC 410 is powered on and initialized, the timing control IC 410 configures data to the panel driving IC 430 through the first IIC bus 441. A signal is sent from the first master port 411 and the second slave port 431 receives the signal.

When the timing control IC 410 works properly, control pins (WPN) on the SoC 420 is H. The SoC 420 controls the timing control IC 410. A signal is sent from the second master port 421 and the first slave port 412 receives the signal.

The first IIC bus 441 is connected to the first master port 411 and the second slave port 431, and is used to complete a signal transmission between the timing control IC 410 and the panel driving IC 430. The second IIC bus 442 is connected to the first slave port 412 and the second master port 421 to complete a signal transmission between the timing control IC 410 and the SoC 420. The first IIC bus 441 and the second IIC bus 442 are independent of each other, which means that the signal transmission between the timing control IC 410 and the panel driving IC 430 and the signal transmission between the timing control IC 410 and the SoC 420 are also independent of each other.

In an embodiment, the circuit board 42 is further provided with the IIC device 45. The IIC device 45 is connected to the second master port 421 through the second IIC bus 442. The IIC device 45 can be an electrically-erasable programmable read-only memory (EEPROM) or other devices.

A device address of the IIC device 45 is different from a device address of the first slave port 412. The first slave port 412 and the IIC device 45 are connected to the second master port 421 through the second IIC bus 442. In an operation state, the SoC 420 sends a signal to the first slave port 412 of the timing control IC 410 through the second master port 421, and if the IIC device 45 also needs to be operated at this time, the second master port 421 also needs to send a signal to the IIC device 45. The device address of the IIC device 45 is different from the device address of the first slave port 412, so that the second master port 421 can accurately control the IIC device 45 and the first slave port 412 through unique addresses, and no signal transmission errors will occur, which is simple and efficient.

In the present application, during a power-on initialization process of the timing control IC 410, the first master port 411 of the timing control IC 410 configures data to the second slave port 431 of the panel driving IC 430 through the first IIC bus 441. If the IIC device 45 also needs to be operated at this time, the second master port 421 of the SoC 420 sends a signal to the IIC device 45 through the second IIC bus 442. The first IIC bus 441 and the second IIC bus 442 are independent of each other, which means that the second slave port 431 only corresponds to the first master port 411, the IIC device 45 also only corresponds to the second master port 421, the panel driving IC 430 only accepts the data configured by the timing control IC 410, and the IIC device 45 only accepts the data configured by the SoC 420, so that there is no bus conflict between the first IIC bus 441 and the second IIC bus 442, thereby ensuring the accuracy of data transmission.

When the timing control IC 410 is in proper operation, the second master port 421 of the SoC 420 sends a signal and transmits it to the first slave port 412 of the timing control IC 410 through the second IIC bus 442, and the timing control IC 410 converts the signal into a signal required by the display panel. When a manufacturer wants to change internal settings of the panel driving IC 430, the timing control IC 410 can send a signal to the panel driving IC 430 through the first IIC bus 441. The first IIC bus 441 and the second IIC bus 442 are independent of each other, which means that the first slave port 412 only corresponds to the second master port 421, the second slave port 431 only corresponds to the first master port 411, the timing control IC 410 only accepts the data configured by the SoC 420, and the panel driving IC 430 only accepts the data configured by the timing control IC 410, so that there is no bus conflict between the first IIC bus 441 and the second IIC bus 442, thereby ensuring the accuracy of data transmission.

The present application provides the second IIC bus 442 and the first IIC bus 441 independently, one is connected to the first master port 411 of the timing control IC 410 and the second slave port 431 of the panel driving IC 430, and another is connected to the first slave port 412 of the timing control IC 410 and the second master port 421 of the SoC 420. Therefore, an independent transmission between the timing control IC 410 and the SoC 420 is implemented, and a technical problem of the IIC bus conflict is solved.

The panel driving IC 430 includes at least one of the P-gamma IC 4301, the power management IC 4302, or the LS IC 4303. In this embodiment, the panel driving IC 430 is a three-in-one IC with the P-gamma IC 4301, the power management IC 4302, and the LS IC 4303, which reduces the space occupied by the control board and saves costs.

In an embodiment, the timing control IC 410 further includes an internal memory, and the internal memory is used to store data transmitted by the second master port 421 and the first slave port 412. The internal memory is a memory space disposed in the timing control IC 410. When the timing control IC 410 is powered on and initialized, the internal memory can store a reading instruction corresponding to the second master port 421 of the SoC 420, data returned by a reading operation, the writing instruction and data, and the storage status of the memory space.

In an embodiment, the timing control IC 410 includes a data acquisition unit to be written, a writing unit, and a verification unit.

The data acquisition unit is used to receive a data to be written.

The writing unit is used to write data to be written into the register of the panel driving IC 430.

The verification unit is used to verify whether the data to be written is successfully written into the register.

In an embodiment, the verification unit includes a reading unit and a comparison unit. The reading unit is used to read actual written data in the register, and the comparison unit is used to compare whether the actual written data is consistent with the data to be written.

The verification unit finishes the verification when the actual written data is consistent with the data to be written. When the actual written data is not consistent with the data to be written, the writing unit is triggered to rewrite the data to be written into the register of the panel driving IC.

The timing control IC further includes a counting unit (not shown in FIG.). The counting unit is used to count how many times of the writing unit writes the data to be written into the register of the panel driving IC, and when the number of times exceeds a threshold, the writing unit is triggered to stop writing the data to be written to the register of the panel driving IC.

For the panel driving IC 430 in the display panel to work properly, the data needs to be written into the panel driving IC 430 first. If an error occurs in the written data, subsequent display will be affected. Therefore, after the timing control IC 410 in this application writes data to the panel driving IC 430, a written result will be verified, and prevent the subsequent display from being abnormal.

Meanwhile, the present application provides a display device. The display device includes the display panel and the display panel driving system. The display panel driving system includes the memory, the timing control IC, and the panel driving IC.

The memory is configured to store driving data.

The timing control IC is electrically connected to the memory and the panel driving IC, is configured to download the driving data from the memory during the startup phase, and send the driving data to the panel driving IC.

The panel driving IC is electrically connected to the display panel and includes the IC main body and the register, and the IC main body is configured to receive the driving data from the timing control IC during the startup phase, write the driving data into the register, and drive the display panel to work according to the driving data stored in the register during the display phase.

In an embodiment of the present application, the panel driving IC includes at least one of the P-gamma IC, the power management IC, or the LS IC.

In an embodiment of the present application, the memory includes the flash memory.

In an embodiment of the present application, the display panel driving system further includes the control board, and the memory, the timing control IC, and the panel driving IC are disposed on the control board.

In an embodiment of the present application, the display panel driving system further includes the timing control board and the source driving control board, the memory includes the first memory and the second memory, the first memory, the timing control IC, and the panel driving IC are disposed on the timing control board, and the second memory is disposed on the source driving control board.

In an embodiment of the present application, the IC main body is configured to verify whether the driving data written to the register is correct during the startup phase, and if the driving data written to the register is not correct, the driving data from the timing control IC is reacquired and written into the register.

In an embodiment of the present application, the IC main body includes:

an acquisition unit configured to receive first driving data from the timing control IC during the startup phase;

a writing unit configured to write the first driving data into the register during the startup phase;

a verifying unit configured to detect whether second driving data stored in the register is same as the first driving data during the startup phase and to determine the driving data written to the register during the startup phase is incorrect when the first driving data is different from the second driving data; and

a rewriting unit configured to reacquire the driving data from the timing control IC and write the driving data into the register when the verifying unit determines the driving data written to the register during the startup phase is incorrect.

In an embodiment of the present application, the verifying unit is further configured to acquire the first verification code corresponding to the first driving data and the second verification code corresponding to the second driving data and compare the first verification code to the second verification code, and when the first verification code is different from the second verification code, the first driving data is determined as different from the second driving data.

In an embodiment of the present application, the verifying unit is further configured to detect whether the second driving data stored in the register is same as the first driving data during the display phase, and when the first driving data is different from the second driving data, the rewriting unit is triggered to reacquire the first driving data from the timing control IC and write the first driving data into the register.

In an embodiment of the present application, the verifying unit is further configured to detect whether the second driving data stored in the register is same as the first driving data during a blank period of a display frame, when the first driving data is different from the second driving data, the rewriting unit is triggered to reacquire the first driving data from the timing control IC and write the first driving data into the register, and when the first driving data is same as the second driving data, the IC main body drives the display panel to work according to the driving data stored in the register during a display period of a next display frame.

Working phases of the display device include the startup phase T1 and the display phase T2. In each display frame T3 of the display phase T2 is divided into the display period T4 and the blank period T5.

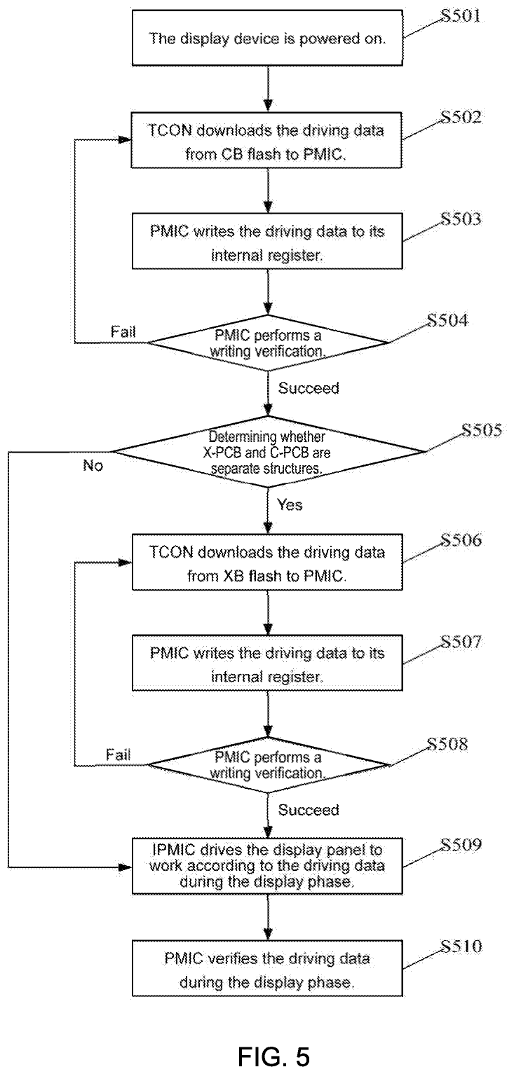

Take the panel driving IC as a power management IC for example. The other types of chips are the same, and will not be described again. The driving method of the present application will be further explained with reference to FIG. 5.

As shown in FIG. 5, the driving method provided by an embodiment of the present application includes the steps of:

S501: the display device is powered on and starts the startup phase T1.

S502: the timing IC (TCON) downloads the driving data from the memory (CB flash) of the timing control board and sends the driving data to the power management IC (PMIC).

S503: the power management IC (PMIC) writes the driving data to its internal register.

In order to ensure the writing is correct, after the step S503, the driving method further includes the step of:

S504: the power management IC (PMIC) performs a writing verification.

If the verification is successful, proceed to the next step. If the verification fails, return to the step S502 again.

This step can include the steps of: receiving first driving data from the timing control IC during the startup phase; writing the first driving data into the register during the startup phase; detecting whether second driving data stored in the register is same as the first driving data during the startup phase and to determine the driving data written to the register during the startup phase is incorrect when the first driving data is different from the second driving data.

This step can include the steps of: acquiring a first verification code corresponding to the first driving data and a second verification code corresponding to the second driving data and compare the first verification code to the second verification code, and when the first verification code is different from the second verification code, the first driving data is determined as different from the second driving data.

This step can include the steps of: using a cyclic redundancy check (CRC) to verify.

In order to be compatible with different architectures, after the step S504, the driving method further includes the steps of:

S505: determining whether X-PCB and C-PCB are separate structures.

If the X-PCB and C-PCB are separate structures, step S506 is performed. If the X-PCB and C-PCB are a combined structure, proceed to the display phase T2.

S506: the timing control IC (TCON) downloads the driving data from the memory (XB flash) of the source driving control board and sends the driving data to the power management IC (PMIC).

S507: the power management IC (PMIC) writes the driving data to its internal register.

In order to ensure the writing is correct, after the step S507, the driving method further includes the step of:

S508: the power management IC (PMIC) performs the writing verification.

If the verification is successful, proceed to the display phase T2. If the verification fails, return to the step S506 again.

S509: the power management IC (PMIC) drives the display panel to work according to the driving data stored in the internal registers during the display phase T2.

In order to further ensure the driving data will not be changed, after this step, the driving method also includes the step of:

S510: the power management IC (PMIC) verifies the driving data during the display phase.

The power management IC (PMIC) verifies whether the driving data is changed during the display phase. The power management IC (PMIC) verifies whether the second driving data actually stored in the register in each display frame T3 such as in the blank period T5 of each display frame T3 is same as the first driving data. When the first driving data is different from the second driving data, the first driving data is reacquired from the timing control IC and written into the register.

If the driving data is not changed, the power management IC (PMIC) drives the display panel to work within the display period T4 of each display frame T3 according to the driving data stored in the internal register.

It can be known from the above embodiments:

The present application provides the display panel driving system and the display device. The display panel driving system includes the memory, the timing control IC, and the panel driving IC. The memory is configured to store driving data. The timing control IC is electrically connected to the memory and the panel driving IC, is configured to download the driving data from the memory during the startup phase, and send the driving data to the panel driving IC. The panel driving IC is electrically connected to the display panel and includes the IC main body and the register, and the IC main body is configured to receive the driving data from the timing control IC during the startup phase, write the driving data into the register, and drive the display panel to work according to the driving data stored in the register during the display phase. Based on this system, the timing control IC downloads the driving data from the memory during the startup phase, the panel driving IC receives the driving data from the timing control IC during the startup phase, writes the driving data to the register, and drives the display panel to work according to the driving data stored in the register during the display phase. Therefore, each IC does not need to be configured with a special memory, and multiple ICs can share a single memory, which solves a technical problem that memories need to be configured in the ICs in the current display panel driving systems and reduces costs.

Understandably, those having ordinary skills of the art may easily contemplate various changes and modifications of the technical solution and technical ideas of the present application and all these changes and modifications are considered in the protection scope of right for the present application.

What is claimed is:

1. A display panel driving system, comprising:
a memory, a timing control integrated circuit (IC), and a panel driving IC;
wherein the memory is configured to store driving data;
wherein the timing control IC is electrically connected to the memory and the panel driving IC, is configured to download the driving data from the memory during a startup phase, and send the driving data to the panel driving IC; and
wherein the panel driving IC is electrically connected to a display panel and comprises an IC main body and a register, and the IC main body is configured to receive the driving data from the timing control IC during the startup phase, write the driving data into the register, and drive the display panel to work according to the driving data stored in the register during a display phase.

2. The display panel driving system according to claim 1, wherein the panel driving IC comprises at least one of a programmable gamma (P-gamma) IC, a power management IC, or a level shifter IC.

3. The display panel driving system according to claim 1, wherein the memory comprises flash memory.

4. The display panel driving system according to claim 1, wherein the display panel driving system further comprises a control board, and the memory, the timing control IC, and the panel driving IC are disposed on the control board.

5. The display panel driving system according to claim 1, wherein the display panel driving system further comprises a timing control board and a source driving control board, the memory comprises a first memory and a second memory, the first memory, the timing control IC, and the panel driving IC are disposed on the timing control board, and the second memory is disposed on the source driving control board.

6. The display panel driving system according to claim 1, wherein the IC main body is configured to verify whether the driving data written to the register is correct during the startup phase, and if the driving data written to the register is not correct, the driving data from the timing control IC is reacquired and written into the register.

7. The display panel driving system according to claim 6, wherein the IC main body comprises:
an acquisition unit configured to receive first driving data from the timing control IC during the startup phase;
a writing unit configured to write the first driving data into the register during the startup phase;
a verifying unit configured to detect whether second driving data stored in the register is same as the first driving data during the startup phase and to determine the driving data written to the register during the startup phase is incorrect when the first driving data is different from the second driving data; and
a rewriting unit configured to reacquire the driving data from the timing control IC and write the driving data into the register when the verifying unit determines the driving data written to the register during the startup phase is incorrect.

8. The display panel driving system according to claim 7, wherein the verifying unit is further configured to acquire a first verification code corresponding to the first driving data and a second verification code corresponding to the second driving data and compare the first verification code to the second verification code, and when the first verification code is different from the second verification code, the first driving data is determined as different from the second driving data.

9. The display panel driving system according to claim 7, wherein the verifying unit is further configured to detect whether the second driving data stored in the register is same as the first driving data during the display phase, and when the first driving data is different from the second driving data, the rewriting unit is triggered to reacquire the first driving data from the timing control IC and write the first driving data into the register.

10. The display panel driving system according to claim 9, wherein the verifying unit is further configured to detect whether the second driving data stored in the register is same as the first driving data during a blank period of a display frame, when the first driving data is different from the second driving data, the rewriting unit is triggered to reacquire the first driving data from the timing control IC and write the first driving data into the register, and when the first driving data is same as the second driving data, the IC main body drives the display panel to work according to the driving data stored in the register during a display period of a next display frame.

11. A display device, comprising:
a display panel and a display panel driving system, the display panel driving system comprising a memory, a timing control integrated circuit (IC), and a panel driving IC;
wherein the memory is configured to store driving data;
wherein the timing control IC is electrically connected to the memory and the panel driving IC, is configured to download the driving data from the memory during a startup phase, and send the driving data to the panel driving IC; and
wherein the panel driving IC is electrically connected to a display panel and comprises an IC main body and a register, and the IC main body is configured to receive the driving data from the timing control IC during the startup phase, write the driving data into the register, and drive the display panel to work according to the driving data stored in the register during a display phase.

12. The display device according to claim 11, wherein the panel driving IC comprises at least one of a programmable gamma (P-gamma) IC, a power management IC, or a level shifter IC.

13. The display device according to claim 11, wherein the memory comprises flash memory.

14. The display device according to claim 11, wherein the display panel driving system further comprises a control board, and the memory, the timing control IC, and the panel driving IC are disposed on the control board.

15. The display device according to claim 11, wherein the display panel driving system further comprises a timing control board and a source driving control board, the memory comprises a first memory and a second memory, the first memory, the timing control IC, and the panel driving IC are disposed on the timing control board, and the second memory is disposed on the source driving control board.

16. The display device according to claim 11, wherein the IC main body is configured to verify whether the driving data written to the register is correct during the startup phase, and if the driving data written to the register is not correct, the driving data from the timing control IC is reacquired and written into the register.

17. The display device according to claim 16, wherein the IC main body comprises:
an acquisition unit configured to receive first driving data from the timing control IC during the startup phase;
a writing unit configured to write the first driving data into the register during the startup phase;
a verifying unit configured to detect whether second driving data stored in the register is same as the first driving data during the startup phase and to determine the driving data written to the register during the startup phase is incorrect when the first driving data is different from the second driving data; and
a rewriting unit configured to reacquire the driving data from the timing control IC and write the driving data into the register when the verifying unit determines the driving data written to the register during the startup phase is incorrect.

18. The display device according to claim 17, wherein the verifying unit is further configured to acquire a first verification code corresponding to the first driving data and a second verification code corresponding to the second driving data and compare the first verification code to the second verification code, and when the first verification code is different from the second verification code, the first driving data is determined as different from the second driving data.

19. The display device according to claim 17, wherein the verifying unit is further configured to detect whether the second driving data stored in the register is same as the first driving data during the display phase, and when the first driving data is different from the second driving data, the rewriting unit is triggered to reacquire the first driving data from the timing control IC and write the first driving data into the register.

20. The display device according to claim 19, wherein the verifying unit is further configured to detect whether the second driving data stored in the register is same as the first driving data during a blank period of a display frame, when the first driving data is different from the second driving data, the rewriting unit is triggered to reacquire the first driving data from the timing control IC and write the first driving data into the register, and when the first driving data is same as the second driving data, the IC main body drives the display panel to work according to the driving data stored in the register during a display period of a next display frame.
